(19) United States
(12) Patent Application Publication
(10) Pub. No.: US 2021/0230406 A1
(43) Pub. Date: Jul. 29, 2021

(54) Expandable Thermoplastic Microsphere Doped Tire Innerliner

(71) Applicant: ExxonMobil Chemical Patents Inc., Baytown, TX (US)

(72) Inventors: Xin Jin, Weifang, Shandong (CN); Michael B. Rodgers, Cedar Park, TX (US); Peite Bao, Shanghai (CN); Shanawas Ck, Bangalore, Karnataka (IN); Babu Shanmugasundaram, Chennai, Tamilnadu (IN)

(21) Appl. No.: 17/053,569

(22) PCT Filed: May 2, 2019
(86) PCT No.: PCT/US2019/030342

§ 371 Date: Nov. 6, 2020

Related U.S. Application Data
(60) Provisional application No. 62/671,113, filed on May 14, 2018.

(51) Int. Cl. C08L 15/02; B60C 1/00

(52) U.S. Cl. CPC C08L 15/02; B60C 1/0008

(57) ABSTRACT

A cured elastomer comprising: an elastomer at 100 parts per hundred rubber (phr); and an expandable thermoplastic microsphere at about 0.1 to about 10 phr. Such a cured elastomer can be used, optionally with additives, in an air barrier article that is selected from the group consisting of a tire innerliner, a pneumatic tire, a tire curing bladder, an air sleeves, a diaphragm, and a hose. With microspheres the compounded cured elastomer shows a reduction in specific gravity and a reduction in permeability. Both of these properties are highly desirable in tire design and performance.

### CROSS-REFERENCE TO RELATED APPLICATIONS

This invention claims priority to and the benefit of U.S. Ser. No. 62/671,113, filed May 14, 2018 and EP Application No. 18177409.2, filed Jun. 12, 2018, which are incorporated herein by reference in their entirety.

### FIELD OF THE INVENTION

The present disclosure relates to elastomers doped with expandable thermoplastic microspheres, their method of manufacture, and their inclusion in air barrier articles such as tire innerliners.

### BACKGROUND OF THE INVENTION

Halogenated isobutylene/isoprene copolymers, also referred to as halogenated butyl rubbers, are the polymers of choice for innerliners of tires for passenger, truck, bus, farm and off-road, and aircraft vehicles because they exhibit low air permeability yet are flexible. Bromobutyl rubber, chlorobutyl rubber, and halogenated star-branched butyl rubbers can be formulated for specific tire applications, such as tubes or innerliners. The selection of ingredients and additives for the final commercial formulation depends upon the balance of the properties desired, namely, processability and tack of the green (uncured) compound in the tire plant versus the in-service performance of the cured tire composite.

While halogenated butyl rubbers exhibit low air permeability, additives such as clays have been compounded with the halogenated butyl rubbers to further reduce the air permeability. However, due to the hydrophobic and polymeric nature of butyl rubber, it is difficult to achieve a good dispersion or effective exfoliation of the clays. Publications that describe blends of elastomers and exfoliated clays include U.S. Patent Application Publication No. 2004/0194863; U.S. Pat. Nos. 7,425,591; 7,485,677; 7,514,491; 7,576,155; 7,985,793; 8,980,978; and 9,475,910; and International Application Publication No. WO/2008/118174.

A need exists to develop additional rubber compositions that possess sufficiently low air permeability and are flexible so as to be suitable in the production of tire innerliners and other air barrier articles.

### SUMMARY OF THE INVENTION

Described herein is a cured elastomer comprising: an elastomer at 100 parts per hundred rubber (phr); and an expandable thermoplastic microsphere at about 0.1 to about 10 phr.

Also disclosed herein is a method comprising: mixing components comprising an elastomer at 100 parts per hundred rubber (phr); and an expandable thermoplastic microsphere at about 0.1 to about 10 phr to produce a doped elastomer, wherein mixing is at a temperature above an expansion initiation temperature and below a maximum exposure temperature for the expandable thermoplastic microspheres; and curing the doped elastomer to produce a cured, doped elastomer.

### DETAILED DESCRIPTION OF THE INVENTION

The present disclosure relates to elastomers doped with expandable thermoplastic microspheres (referred to herein as “doped elastomer compositions”), their method of manufacture, and their inclusion in air barrier articles such as tire innerliners. More specifically, doped elastomers described herein can comprise an elastomer (preferably a halogenated butyl rubber) at about 100 parts per hundred rubber (phr) and expandable thermoplastic microspheres at about 0.1 phr to about 5 phr. Optionally, other additives can be included for specific applications. For example, doped elastomers for a tire innerliner can comprise halogenated butyl rubber at about 100 phr, expandable thermoplastic microspheres at about 0.1 phr to about 5 phr, an antidusting agent at about 0.1 phr to about 3 phr, a filler at about 20 phr to about 90 phr, a processing oil at about 0.1 phr to about 10 phr, a phenolic resin at about 1 to about 15 phr, and a curing agent, and system, at 0 phr to about 15 phr.

### Definitions

The various descriptive elements and numerical ranges disclosed herein can be combined with other descriptive elements and numerical ranges to describe preferred embodiments of the compositions, air barrier articles (e.g., innerliners and tires comprising innerliners), and processes to make such described herein; further, any upper numerical limit of an element can be combined with any lower numerical limit of the same element to describe preferred embodiments. In this regard, the phrase “within the range from X to Y” is intended to include within that range the “X” and “Y” values.

Unless otherwise noted, if an amount of a component is stated, that amount is understood to be an aggregate amount if two or more different species of that component are present together.

As used herein, “polymer” may be used to refer to homopolymers, copolymers, interpolymers, terpolymers, etc. Likewise, a copolymer may refer to a polymer comprising at least two monomers, optionally with other monomers. As used herein, when a polymer is referred to as “comprising” a monomer, the monomer is present in the polymer in the polymerized form of the monomer or in the derivative form of the monomer. Likewise, when catalyst components are described as comprising neutral stable forms of the components, it is well understood by one skilled in the art, that the ionic form of the component is the form that reacts with the monomers to produce polymers.

As used herein, “elastomer” or “elastomeric composition” refers to any polymer or composition of polymers (such as blends of polymers) consistent with the ASTM D1566 definition. Elastomer includes mixed blends of polymers such as melt mixing and/or reactor blends of polymers. The terms may be used interchangeably with the term “rubber.”

As used herein, “phr” is parts per hundred rubber and is a measure common in the art wherein components of a composition are measured relative to a major elastomer component, based upon 100 parts by weight of the elastomer(s) or rubber(s). Unless otherwise noted, values of phr are significant to the hundredths decimal place. Thus, the expressions “1 phr” and “60 phr” are equivalent to 1.00 phr and 60.00 phr, respectively.

As used herein, “isobutylene-based elastomer” or “isobutylene-based polymer” or “isobutylene-based rubber” refers to elastomers or polymers comprising at least 70 mole percent isobutylene.

As used herein, the term “doped elastomer composition” is a general term for all compositions of the present disclosure. The term does not, unless otherwise specified, delineate at what point during production (mixing, molding, or curing) is at and encompasses a cured, doped elastomer composition or a mixture (or compound) of the components suitable for producing the cured, doped elastomer composition.

### Expandable Thermoplastic Microspheres

Expandable thermoplastic microspheres are hollow spheres with the thermoplastic shell encapsulating a gas. When heated, the thermoplastic shell softens and the encapsulated gas expands, which increases the microsphere diameter and volume. For example, a 12 micron diameter expandable thermoplastic microsphere with a shell thickness of 2 microns can, when heated, expand to 40 microns in diameter with a shell thickness of 0.1 microns. As used herein, the term “expandable thermoplastic microspheres,” unless otherwise specified, does not indicate the state of expansion and encompasses an unexpanded state and an expanded state. As used herein, the term “expanded,” unless otherwise specified as fully expanded, encompasses partially and fully expanded.

Expandable thermoplastic microspheres can be included in the doped elastomer compositions described herein at about 0.1 phr to about 10 phr, about 0.5 phr to about 7 phr, or about 1 phr to about 5 phr.

Expandable thermoplastic microspheres can have an average unexpanded diameter of about 5 microns to about 50 microns, about 10 microns to about 40 microns, about 10 microns to about 20 microns, or about 20 microns to about 40 microns.

Expandable thermoplastic microspheres can have an average fully expanded diameter of about 10 microns to about 125 microns, about 15 microns to about 100 microns, about 25 microns to about 85 microns, or about 30 microns to about 50 microns.

Expandable thermoplastic microspheres can have a density of about 5 kg/m³ to about 75 kg/m³, about 5 kg/m³ to about 30 kg/m³, or about 5 kg/m³ to about 10 kg/m³ or about 10 kg/m³ to about 25 kg/m³.

The temperature at which the expandable thermoplastic microspheres begin expansion (expansion initiation temperature) and the maximum exposure temperature for the expandable thermoplastic microspheres before degradation or explosion depends on the shell dimensions and the shell composition.

The expansion initiation temperature can be from about 80° C. to about 175° C., about 80° C. to about 115° C., about 115° C. to about 135° C., or about 135° C. to about 175° C.

The maximum exposure temperature for the expandable thermoplastic microspheres before degradation or explosion can be from about 120° C. to about 210° C., about 120° C. to about 175° C., or about 175° C. to about 210° C.

Examples of commercially available expandable thermoplastic microspheres include, but are not limited to, the grades of EXPANCEL™ DU (unexpanded thermoplastic microspheres, available from AkzoNobel) listed in Table 1 and the grades of EXPANCEL™ DE (expanded thermoplastic microspheres, available from AkzoNobel) listed in Table 2.

TABLE 1
Examples of EXPANCEL ™ DU

| | Average | Expansion | Maximum | |
|---|---|---|---|---|
| | Unexpanded | Initiation | Exposure | |
| | Diameter | Temperature | Temperature | Density |
| Grade | (microns) | (° C.) | (° C.) | (kg/m³) |
| 551 DU 40 | 10-16 | 94-99 | 141-149 | ≤17 |
| 461 DU 20 | 6-9 | 100-106 | 143-51 | ≤30 |
| 461 DU 40 | 9-15 | 98-104 | 144-152 | ≤20 |
| 051 DU 40 | 9-15 | 108-113 | 142-151 | ≤25 |
| 031 DU 40 | 10-16 | 80-95 | 120-135 | ≤12 |
| 053 DU 40 | 10-16 | 96-103 | 138-146 | ≤20 |
| 093 DU 120 | 28-38 | 120-130 | 189-204 | ≤6.5 |
| 909 DU 80 | 18-24 | 120-130 | 175-190 | ≤10 |
| 920 DU 20 | 5-9 | 120-145 | 155-175 | ≤25 |
| 920 DU 40 | 10-16 | 123-133 | 168-178 | ≤17 |
| 920 DU 80 | 18-24 | 123-133 | 180-195 | ≤14 |
| 920 DU 120 | 28-38 | 122-132 | 194-206 | ≤14 |
| 930 DU 120 | 28-38 | 122-132 | 192-207 | ≤6.5 |
| 950 DU 80 | 18-24 | 138-148 | 188-20 | ≤12 |
| 951 DU 120 | 28-38 | 133-143 | 190-205 | ≤9 |
| 980 DU 120 | 25-40 | 158-173 | 215-235 | ≤14 |
| 043 DU 80 | 16-24 | 95-115 | 147-167 | ≤10 |

TABLE 2
Examples of EXPANCEL ™ DE

| | Average Unexpanded | |
|---|---|---|
| Grade | Diameter (microns) | Density (kg/m³) |
| 551 DE 40 d42 | 30-50 | 42 ± 4 |
| 551 DE 40 d42 ± 2 | 30-50 | 42 ± 2 |
| 461 DE 20 d70 | 15-25 | 70 ± 6 |
| 461 DE 40 d60 | 20-40 | 60 ± 5 |
| 461 DET 40 d25 | 35-55 | 25 ± 3 |
| 092 DET 100 d25 | 80-120 | 25 ± 3 |
| 920 DE 40 d30 | 35-55 | 30 ± 3 |
| 920 DET40 d25 | 30-60 | 25 ± 3 |
| 920 DE 80 d30 | 55-85 | 30 ± 3 |
| 043 DET 80 d20 | 60-95 | 20 ± 3 |

### Elastomer

The doped elastomer compositions described herein comprise at least one elastomer. Elastomers can be selected from the group consisting butyl rubber (isoprene-isobutylene rubber, “IIR”), branched (“star-branched”) butyl rubber, star-branched polyisobutylene rubber, bromobutyl rubber (“BIIR”), chlorobutyl rubber (“CIIR”), random copolymers of isobutylene and para-methylstyrene (poly(isobutylene-co-p-methylstyrene)), halogenated poly(isobutylene-co-p-methylstyrene) (“BIMSM”), polybutadiene rubber (“BR”), high cis-polybutadiene, polyisoprene rubber, isoprene-butadiene rubber (“IBR”), styrene-isoprene-butadiene rubber (“SIBR”), styrene-butadiene rubber (“SBR”), solution-styrene-butadiene rubber (“sSBR”), emulsion-styrene-butadiene rubber, nitrile rubber, ethylene propylene rubber (“EP”), ethylene-propylene-diene rubber (“EPDM”), synthetic-polyisoprene, general purpose rubber, natural rubber, any halogenated versions of these elastomers, and combinations thereof. Preferred elastomers include isobutylene based elastomers such as, butyl rubber, halogenated butyl rubber, and halogenated poly(isobutylene-co-p-methylstyrene). Commercial examples include, but are not limited to, EXXPRO™ elastomers (halogenated random copolymers of isobutylene and para-methylstyrene, available from ExxonMobil Chemical Company), EXXON™ 2222 (brominated copolymer of isobutylene and isoprene, available from ExxonMobil Chemical Company), EXXON™ 2255 (brominated copolymer of isobutylene and isoprene, available from ExxonMobil Chemical Company), EXXON™ 6222 (brominated star-branched copolymer of isobutylene and isoprene, available from ExxonMobil Chemical Company), EXXON™ 1066 (chlorinated copolymer of isobutylene and isoprene, available from ExxonMobil Chemical Company), and combinations thereof.

The elastomer in total is in the doped elastomer compositions described herein at 100 phr. For example, a doped elastomer composition can include 30-50 phr butyl rubber, 30-50 phr bromobutyl rubber, 30-50 phr chlorobutyl, and 30-50 phr BIMSM.

### Additives

Depending on the specific application, the doped elastomer compositions described herein can optionally further comprise one or more additives, which include, but are not limited to, antidusting agents, fillers, processing oils, curing agents, activators, retarders, pigments, antioxidants, antiozonants, and combinations thereof.

Expandable thermoplastic microspheres have a very low density and, therefore, tend to float in the air when added during compounding. This is especially a problem when an open mixer is used. Antidusting agents can be used to mitigate floating of the expandable thermoplastic microspheres so as to maintain the microspheres in contact with the rubber until incorporated. Examples of antidusting agents include, but are not limited to, calcium carbonate, clays, and combinations thereof.

Antidusting agents, when included, can be in the doped elastomer composition at about 0.1 phr to about 3 phr, about 1 phr to about 3 phr, or about 1.5 phr to about 2.5 phr.

Fillers can improve the mechanical properties and/or barrier properties of the doped elastomer compositions described herein. Examples of fillers include, but are not limited to, silica, talc, titanium dioxide, and carbon black.

Silica is meant to refer to any type or particle size silica or another silicic acid derivative, or silicic acid, processed by solution, pyrogenic or the like methods and having a surface area, including untreated, precipitated silica, crystalline silica, colloidal silica, aluminum or calcium silicates, fumed silica, and combinations thereof.

Preferably, carbon black has a surface area of less than 40 m²/g and a dibutylphthalate oil absorption of less than 80 cm³/100 gm. Examples of carbon blacks include, but are not limited to N550, N660, N650, N762, and N990 provided in ASTM (D3037, D1510, and D3765), Regal® 85 (carbon black, available from Cabot), Regal® 90 (carbon black, available from Cabot), and combinations thereof.

Fillers, when included, can be in the doped elastomer composition at about 20 phr to about 90 phr, about 30 phr to about 80 phr, or about 40 phr to about 70 phr.

Processing oils are primarily used to improve the processability of the composition during compounding and molding. Processing oils can be petroleum-derived processing oils, synthetic plasticizers, or a combination thereof. Examples of processing oils include, but are not limited to, paraffinic oils, naphthenic oils, aromatic oils, mild extraction solvate (MES), treated distillate aromatic extract (TDAE), and combinations thereof. The preferred plasticizer oil for use in standard, non-DVA (dynamic vulcanized alloy), non-engineering resin-containing innerliner compositions is a paraffinic petroleum oil; suitable hydrocarbon plasticizer oils for use in such innerliners include oils having the following general characteristics.

Processing oils, when included, can be in the doped elastomer composition at about 0.1 phr to about 10 phr, about 1 phr to about 7 phr, or about 3 phr to about 5 phr.

Tackifying resins also improve the processability of the composition. Examples of tackifying resins include, but are not limited to, aliphatic hydrocarbon resins, at least partially hydrogenated aliphatic hydrocarbon resins, aliphatic/aromatic hydrocarbon resins, at least partially hydrogenated aliphatic aromatic hydrocarbon resins, cycloaliphatic hydrocarbon resins, at least partially hydrogenated cycloaliphatic resins, cycloaliphatic/aromatic hydrocarbon resins, at least partially hydrogenated cycloaliphatic/aromatic hydrocarbon resins, aromatic hydrocarbon resins, dicyclopentadiene derivatives, at least partially hydrogenated aromatic hydrocarbon resins, polyterpene resins, terpene-phenol resins, rosin esters, rosin acids, resins grafted with graft monomers, and combinations thereof.

Tackifying resins, when included, can be in the doped elastomer composition at about 0.1 phr to about 10 phr, about 1 phr to about 7 phr, or about 3 phr to about 5 phr.

Curing agents can include curatives, phenolic resins, vulcanizing agents, crosslinking agents, and the like. In total, curing agents, when included, can be in the doped elastomer composition at about 0.1 phr to about 15 phr, about 1 phr to about 10 phr, or about 5 phr to about 8 phr.

Examples of curative include, but are not limited to, ZnO, CaO, MgO, Al₂O₃, CrO₃, FeO, Fe₂O₃, and NiO. These metal oxides can be used alone or in conjunction with the corresponding metal fatty acid complex (e.g., zinc stearate, calcium stearate, etc.), or with the organic and fatty acids added alone, such as stearic acid, and optionally other curatives such as sulfur or a sulfur compound, an alkylperoxide compound, diamines, diamine derivatives (e.g., DIAK™, available from DuPont), and combinations thereof.

Curing elastomers with curatives may be accelerated and is often used for the vulcanization of elastomers. The mechanism for accelerated vulcanization of natural rubber involves complex interactions between the curative, accelerator, activators, and polymers. Preferably, all of the available curative is consumed in the formation of effective crosslinks that join together two polymer chains and enhance the overall strength of the polymer matrix. Numerous accelerators are known in the art and include, but are not limited to, stearic acid, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), hexamethylene-1,6-bisthiosulfate disodium salt dihydrate (e.g., DURALINK™ HTS, available from Flexsys), 2-morpholinothio benzothiazole (MBS or MOR), blends of 90% MOR and 10% MBTS (MOR 90), N-tertiarybutyl-2-benzothiazole sulfenamide (TBBS), N-oxydiethylene thiocarbamyl-N-oxydiethylene sulfonamide (OTOS), zinc 2-ethyl hexanoate (ZEH), thioureas, and combinations thereof.

Curatives, when included, can be in the doped elastomer composition at about 0.1 phr to about 10 phr, about 1 phr to about 8 phr, or about 3 phr to about 7 phr.

Phenolic resins (or phenol formaldehyde resins) can be used as a curative. Examples of phenol formaldehyde resin include resins having the following structure:

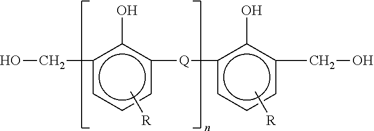

wherein m ranges from 1 to 50, more preferably from 2 to 10; R is selected from the group consisting of hydrogen and C₁ to C₂₀ alkyls in one embodiment; and is selected from the group consisting of C₄ to C₁₄ branched alkyls in a particular embodiment; and Q is a divalent radical selected from the group consisting of —CH₂—, and —CH₂—O—CH₂—. Mixtures of phenolic resins can be used.

Phenolic resins can be in any form such as a solid, liquid, solution, or suspension. Suitable solvents or diluents include liquid alkanes (e.g., pentane, hexane, heptane, octane, cyclohexane), toluene and other aromatic solvents, paraffinic oils, polyolefinic oils, mineral oils, silicon oils, and combinations thereof.

Phenolic resins, when included, can be in the doped elastomer composition at about 0.1 phr to about 10 phr, about 1 phr to about 8 phr, or about 3 phr to about 7 phr.

One or more crosslinking agents, such as a coupling agent, can also be used, especially when silica is also present in the composition. The coupling agent may be a bifunctional organosilane crosslinking agent, which is any silane coupled filler and/or crosslinking activator and/or silane reinforcing agent. Examples of coupling agents include, but not limited to, vinyl triethoxysilane, bis-(3-triethoxysilypropyl)tetrasulfide, vinyl-tris-(beta-methoxyethoxy)silane, methacryloylpropyltrimethoxysilane, gamma-amino-propyl triethoxysilane (e.g., A1100™, available from Witco), gamma-mercaptopropyltrimethoxysilane (e.g., A189™, available from by Witco), and combinations thereof.

Homogenizing agents can enhance the processability of rubber during mixing, extruding, and molding. An example of a homogenization agent includes STRUKTOL™ 40 MS (mixture of dark aromatic hydrocarbon resins, available from Struktol Company).

Such agents, when included, can be in the doped elastomer composition at about 0.1 phr to about 15 phr, about 3 phr to about 12 phr, or about 5 phr to about 10 phr.

### Processing

The doped elastomer compositions described herein can be formed into air barrier articles such as tire innerliners, pneumatic tires, tire curing bladders, air sleeves (e.g., air shock absorbers), diaphragms, hoses (e.g., gas and fluid transporting hoses). Generally, the articles are prepared by mixing the components at a temperature above the expansion initiation temperature and below the maximum exposure temperature for the expandable thermoplastic microspheres, shaping the mixed components into a desired shape, and then curing to produce the article comprising the cured, doped elastomer composition.

Mixing (or compounding) the components can be carried out by combining the components in any suitable internal mixing device such as a BANBURY™ mixer, BRABENDER™ mixer, a Krupp internal mixer with intermeshing rotors, or extruder (e.g., a single screw extruder or twin screw extruder). Mixing can be performed at temperatures above the expansion initiation temperature and below the maximum exposure temperature for the expandable thermoplastic microspheres and at a rate sufficient to allow the expandable thermoplastic microspheres and additives to become uniformly dispersed within the rubber.

Mixing can occur in a single step or multiple steps. For example, the components of the doped elastomer compositions except the curing agents can be mixed in a non-productive stage. Then, the curing agents can be mixed into the compositions during a productive stage.

Suitable mixing rates can range from about 10 RPM to about 100 RPM. Preferably, the mixing rate can range from a low of about 10 RPM, 30 RPM, or 50 RPM to a high of about 60 RPM, 80 RPM, or 100 RPM.

After mixing, the doped elastomer composition is shaped (or formed) into the desired shape. Suitable methods include, but are not limited to, extruding, calendaring, and combinations thereof. For example when producing innerliner, an innerliner layer or “stock” is prepared by (1) calendaring or extruding the doped elastomer composition into a sheet having a thickness of 0.5 mm to 2 mm and (2) cutting the sheet material into strips of appropriate width and length for innerliner application in a particular size or type tire. The liner can then be cured while in contact with the tire carcass and/or sidewall in which it is placed.

Curing temperatures can be about 100° C. to about 250° C., or about 125° C. to about 200° C. Curing times can be minutes to hours, about one minute to about 3 hours, or about 5 minutes to about 30 minutes.

### Example Compositions and Methods

Example 1. A cured elastomer comprising: an elastomer at 100 parts per hundred rubber (phr); and an expandable thermoplastic microsphere at about 0.1 to about 10 phr.

Example 2. The cured elastomer of example 1, wherein the elastomer comprises about 50 phr to about 100 phr halogenated butyl rubber.

Example 3. The cured elastomer of any of the preceding examples, wherein the elastomer comprises bromobutyl rubber, chlorobutyl rubber, or a combination thereof at about 50 phr to about 100 phr.

Example 4. The cured elastomer of any of the preceding examples, wherein the expandable thermoplastic microsphere has an average unexpanded diameter of about 5 microns to about 50 microns.

Example 5. The cured elastomer of any of the preceding examples, wherein the expandable thermoplastic microsphere has a density of about 5 to about 30 kg/m³.

Example 6. The cured elastomer of any of the preceding examples further comprising: an antidusting agent about 0.1 to about 3 phr.

Example 7. The cured elastomer of any of the preceding examples further comprising:

a filler at about 20 phr to about 90 phr.

Example 8. The cured elastomer of any of the preceding examples further comprising: a processing oil at about 0.1 to about 10 phr.

Example 9. The cured elastomer of any of the preceding examples further comprising: a tackifier at about 0.1 phr to about 10 phr.

Example 10. The cured elastomer of any of the preceding examples further comprising: a phenolic resin about 1 phr to about 10 phr.

Example 11. The cured elastomer of any of the preceding examples further comprising: a curative at about 0.1 phr to about 10 phr.

Example 12. The cured elastomer of any of the preceding examples further comprising: a peptizer at about 0.1 phr to about 1.0 phr.

Example 13. The cured elastomer of any of the preceding examples further comprising: a peptizer at about 1 phr to about 15 phr.

Example 14. The cured elastomer of any of the preceding examples comprising: the elastomer at 100 phr, the elastomer comprising bromobutyl rubber at about 50 phr to 100 phr; the expandable thermoplastic microsphere at about 1 to about 5 phr; the antidusting agent about 1 to about 3 phr, the antidusting agent comprising calcium carbonate, clay, wax, or a combination thereof; the filler at about 40 phr to about 70 phr, the filler comprising carbon black; the processing oil at about 5 to about 10 phr; the tackifier at about 5 phr to about 10 phr; and the phenolic resin and the curative in total at about 1 phr to about 10 phr.

Example 15. An air barrier article comprising the cured elastomer of any of the preceding examples, wherein the air barrier article is selected from the group consisting of a tire innerliner, a pneumatic tire, a tire curing bladder, an air sleeves, a diaphragm, and a hose.

Example 16. A tire comprising an innerliner made from the cured elastomer of one of examples 1-14.

Example 17. A method comprising: mixing components comprising an elastomer at 100 parts per hundred rubber (phr); and an expandable thermoplastic microsphere at about 0.1 to about 10 phr to produce a doped elastomer, wherein mixing is at a temperature above an expansion initiation temperature and below a maximum exposure temperature for the expandable thermoplastic microspheres; and curing the doped elastomer to produce a cured, doped elastomer.

Example 18. The method of example 16, wherein the mixing temperature is about 80° C. to about 235° C.

Example 19. The method of one of examples 16-17, wherein the expandable thermoplastic microsphere has an average unexpanded diameter of about 5 microns to about 50 microns.

Example 20. The method of one of examples 16-18, wherein the expandable thermoplastic microsphere has a density of about 5 to about 30 kg/m³.

Example 21. The method of one of examples 16-19 further comprising: shaping the elastomer compound into an innerliner shape in a tire before curing.

Example 22. The method of one of examples 16-20, wherein the components further comprise an antidusting agent about 1 to about 3 phr, a filler at about 20 phr to about 90 phr, a processing oil at about 0.1 to about 10 phr, a tackifier at about 0.1 phr to about 10 phr, and a curing agent at about 0.1 phr to about 10 phr.

Example 23. The method of one of examples 16-21, wherein the components comprise: the elastomer at 100 phr, the elastomer comprising bromobutyl rubber at about 50 phr to 100 phr; the expandable thermoplastic microsphere at about 1 to about 5 phr; the antidusting agent about 1 to about 3 phr, the antidusting agent comprising calcium carbonate, wax, clay, or a combination thereof; the filler at about 40 phr to about 70 phr, the filler comprising carbon black; the processing oil at about 5 to about 10 phr; the tackifier at about 5 phr to about 10 phr; and a phenolic resin and a curative in total at about 1 phr to about 10 phr.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

Three elastomer compositions were prepared according the formulations in Table 3. The components were mixed in an open mixer. Therefore, a calcium carbonate antidusting agent was used to mitigate floating of the expandable thermoplastic microspheres and maximize their incorporation into the composition.

TABLE 3
Elastomer composition formulations

| | Sample 1 | | |
|---|---|---|---|
| Component* | (control) | Sample 2 | Sample 3 |
| EXXON ™ 2222 | 100 | 100 | 100 |
| N660 carbon black | 60 | 60 | 60 |
| Napthenic oil | 8 | 8 | 8 |
| STRUKTOL ™ 40 MS | 7 | 7 | 7 |
| SP-1068 resin | 4 | 4 | 4 |
| Stearic acid | 1 | 1 | 1 |
| MgO | 0.15 | — | — |
| ZnO | 1 | 1 | 1 |
| MBTS | 1.25 | 1.25 | 1.25 |
| Sulfur | 0.5 | 0.5 | 0.5 |
| CaCO₃ | — | 2 | 2 |
| EXPANCEL ™ 909 DU 80 | — | 2 | — |
| EXPANCEL ™ 930 DU 120 | — | — | 2 |

*SP-1068 resin (a thermoplastic resin made from octylphenol and formaldehyde, available from Akrochem Corporation)

The components were mixed together, formed into innerliner green compounds, and then cured at 160° C. or 180° C. The rheological properties (moving die rheometer temperature of 160° C.), air barrier properties (Mocon permeability test temperature of 40° C.), and mechanical properties of the compositions are provided in Table 4.

TABLE 4
Sample properties

| | | |
|---|---|---|
| Sample 1 | | |
| (control) | Sample 2 | Sample 3 |

Rheological Properties*

| | | | |
|---|---|---|---|
| Mooney Scorch Mm (MU) | 39.1 | 36.2 | 36.1 |
| Mh-ML (dNm) | 5.26 | 5.77 | 5.81 |
| t10 (min) | 2.5 | 3.1 | 3.07 |
| t90 (min) | 21.7 | 29.57 | 29.56 |
| Vulcanization rate (dNm/min) | 5.21 | 3.78 | 3.78 |

Air Permeability Properties**

| | | | |
|---|---|---|---|
| Permeation (cc*mm/m²day) | 244 | 233 | 205 |
| Permeability | 0.36 | 0.34 | 0.30 |
| (cc*mm/m²day · mmHg) | | | |
| Permeation rating (% | 100 | 96 | 84 |
| relative to Sample 1) | | | |
| Permeability rating (% | 100 | 96 | 84 |
| relative to Sample 1) | | | |

Mechanical Properties***

| | | | |
|---|---|---|---|
| Hardness (Shore A) | 48 | 46 | 45 |
| Density (g/cm³) | 1.13 | 1.09 | 1.014 |
| 100% tensile modulus (MPa) | 1.258 | 1.119 | 1.2 |
| 200% tensile modulus (MPa) | 2.726 | 2.254 | 2.261 |
| 300% tensile modulus (MPa) | 4.375 | 3.842 | 3.722 |
| Tensile at break (MPa) | 10.533 | 9.122 | 7.428 |
| Elongation at break (%) | 770 | 660 | 590 |

*Measured according to BRDTC OP-01 (Based on ASTM D5289)
**Measured according to BRDTC OP-65
***Hardness measured according to BRDTC OP-07 (Based on ASTM D2240), Cure physical properties measured according to BRDTC OP-03 (Based on ASTM D412)

The rheology property of Samples 2 and 3 are within acceptable limits that allow for processing the compounds by standard methods.

The air permeability properties are decreased by 4% and 16% for Samples 2 and 3, respectively, which means the permeability to air is reduced and the compounds' suitability for use in an air barrier article is enhanced.

The hardness, tensile strength, and elongation for Samples 2 and 3 are within acceptable limits for tire innerliner and other air barrier applications. However, the density is advantageously reduced by as much as 10%.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A cured elastomer comprising:
an elastomer at 100 parts per hundred rubber (phr); and
an expandable thermoplastic microsphere at about 0.1 to about 10 phr.

2. The cured elastomer of claim 1, wherein the elastomer comprises about 50 phr to about 100 phr halogenated butyl rubber.

3. The cured elastomer of claim 1, wherein the elastomer comprises bromobutyl rubber, chlorobutyl rubber, natural rubber or a combination thereof at about 50 phr to about 100 phr.

4. The cured elastomer of claim 1, wherein the expandable thermoplastic microsphere has an average unexpanded diameter of about 5 microns to about 50 microns.

5. The cured elastomer of claim 1, wherein the expandable thermoplastic microsphere has a density of about 5 to about 30 kg/m³.

6. The cured elastomer of claim 1 further comprising:
an antidusting agent about 0.1 to about 3 phr.

7. The cured elastomer of claim 1 further comprising:
a filler at about 20 phr to about 90 phr.

8. The cured elastomer of claim 1 further comprising:
a processing oil at about 0.1 to about 10 phr.

9. The cured elastomer of claim 1 further comprising:
a tackifier at about 0.1 phr to about 10 phr.

10. The cured elastomer of claim 1 further comprising:
a phenolic resin about 1 phr to about 10 phr.

11. The cured elastomer of claim 1 further comprising:
a curative at about 0.1 phr to about 10 phr.

12. The cured elastomer of claim 1 further comprising:
a homogenizing agent at about 0.1 phr to about 15 phr.

13. The cured elastomer of claim 1, wherein:
the elastomer comprises bromobutyl rubber at about 50 phr to 100 phr; and
the expandable thermoplastic microsphere is at about 1 to about 5 phr.

14. An air barrier article comprising the cured elastomer of claim 1, wherein the air barrier article is selected from the group consisting of a tire innerliner, a pneumatic tire, a tire curing bladder, an air sleeve, a diaphragm, and a hose.

15. An air barrier article of claim 14, wherein the air permeability properties are decreased by about 4% to about 16%, as compared to the same air barrier article without the expandable thermoplastic microsphere.

16. An air barrier article of claim 14, wherein the density is reduced by about 3% to about 10%, as compared to the same air barrier article without the expandable thermoplastic microsphere.

17. A tire comprising an innerliner made from the cured elastomer of claim 1.

18. A method comprising:
mixing components comprising an elastomer at 100 parts per hundred rubber (phr); and an expandable thermoplastic microsphere at about 0.1 to about 10 phr to produce a doped elastomer, wherein mixing is at a temperature above an expansion initiation temperature and below a maximum exposure temperature for the expandable thermoplastic microspheres; and
curing the doped elastomer to produce a cured, doped elastomer.

19. The method of claim 18, wherein the mixing temperature is about 80° C. to about 235° C.

20. The method of claim 18, wherein the expandable thermoplastic microsphere has an average unexpanded diameter of about 5 microns to about 50 microns.

21. The method of claim 18, wherein the expandable thermoplastic microsphere has a density of about 5 to about 30 kg/m³.

22. The method of claim 18:
shaping the elastomer compound into an innerliner shape in a tire before curing.

23. The method of claim 18, wherein the components further comprise an antidusting agent about 1 to about 3 phr, a filler at about 20 phr to about 90 phr, a processing oil at about 0.1 to about 10 phr, a tackifier at about 0.1 phr to about 10 phr, and a curing agent at about 0.1 phr to about 10 phr.

24. The method of claim 23, wherein the components comprise:
the elastomer at 100 phr, the elastomer comprising bromobutyl rubber at about 50 phr to 100 phr;
the expandable thermoplastic microsphere at about 1 to about 5 phr;
the antidusting agent about 1 to about 3 phr, the antidusting agent comprising calcium carbonate, clay, or a combination thereof;
the filler at about 40 phr to about 70 phr, the filler comprising carbon black;
the processing oil at about 5 to about 10 phr;
the tackifier at about 5 phr to about 10 phr; and
a phenolic resin and a curative in total at about 1 phr to about 10 phr.
